(19) United States
(12) Patent Application Publication
(10) Pub. No.: US 2005/0010961 A1
(43) Pub. Date: Jan. 13, 2005

(54) System for providing live and pre-recorded audio-video content to a plurality of portals over the Internet

(76) Inventors: David A. Hagen, Southern Pines, NC (US); Rick Stefanik, Pinehurst, NC (US)

Correspondence Address: SMITH MOORE LLP, P.O. BOX 21927, GREENSBORO, NC, 27420, US

(21) Appl. No.: 10/858,825

(22) Filed: Jun. 2, 2004

Related U.S. Application Data
(60) Provisional application No. 60/474,963, filed on Jun. 2, 2003.

(51) Int. Cl. H04N 7/173; G06F 17/30; G06F 7/00

(52) U.S. Cl. 725/119; 725/120; 725/126

(57) ABSTRACT

A system for providing audiovisual media to a plurality of portals on a network including a central request server on the network that stores the media, at least one requesting portal that requests the media from the central request server, and a gateway server that is selected by the central request server to process the request from the requesting portal. The central request server replicates the media onto the selected gateway server and the selected gateway server replicates the media onto the requesting portal.

This application claims the benefit of U.S. Provisional Application No. 60/474,963, filed on Jun. 2, 2003.

### BACKGROUND OF THE INVENTION

The present invention relates to a system for providing pre-recorded audio-video content to a plurality of customers over the Internet while providing efficient, global load balancing.

Almost every television viewer can relate to rushing home to view a particular program on time or being disappointed because the program was already over. This is because viewers generally watch television programs as the signal is broadcasted from the television station unless the viewer plans in advance to record the program on a videocassette recorder (VCR) or the like. However, with the onset of “video-on-demand” system, viewers are taking advantage of being able to view a program or movie of their choice, when they want. These systems typically comprise one server or set of servers that stores audiovisual content and processes requests from client portals requesting to view a program. Naturally, this one server or set of servers cannot process an infinite number of requests. Therefore, when a popular program is requested by millions of customers, the server or set of servers becomes overloaded and has to reject further requests.

Accordingly, there is a need in the art for a video on demand television system that provides live and pre-recorded content to a plurality of requesting portals while also providing for efficient, global load balancing.

### BRIEF SUMMARY OF THE INVENTION

A system for providing audiovisual media to a plurality of portals on a network including a central request server on the network that stores the media, at least one requesting portal that requests the media from the central request server, and a gateway server that is selected by the central request server to process the request from the requesting portal. The central request server replicates the media onto the selected gateway server and the selected gateway server replicates the media onto the requesting portal.

### DETAILED DESCRIPTION OF THE INVENTION

The present invention provides an improved system for providing live and pre-recorded audio-video content to customers upon demand. To this end, a network must be in place to allow communication over the Internet between a central request sever and a plurality of portals.

A managed portal network is provided that interfaces with the Internet and particularly with the worldwide web. A plurality of portals may be connected directly to the managed network indirectly through an Internet service provider or through some other medium. The portals of the present invention may comprise computers that may reside in the form of television set-top-boxes, portable kiosks, desktop computers, laptops, handheld computers, web tablets, and personal digital assistants, for example.

To aid in describing the system of the present invention, an example of a viewer that requests to view a particular program or movie via his or her set-top-box is used throughout this description. It should be understood, however, the present invention is not limited to this particular application.

The process of making audiovisual content available to a plurality of portals begins when a television program, for example, is broadcasted from a television station. As the program is aired live from the station, the audiovisual content is encrypted, categorized, indexed, and made available for live streaming or stored on a central request server on the network. Particularly, the content is made available for live streaming or is stored along with corresponding text files that identify and describe the content. This information may be provided to customers when they request information about the program. Also, the content is preferably encrypted so that the content is scrambled if the customer attempts to route the output content from the set-top-box to a video recorder or another viewer, for example. This protects the copyrights in the content.

Once the program is successfully stored on the central request server, the server is available to accept requests for that program from customers using the plurality portals. When a customer decides to view a pre-recorded program, he or she preferably uses an onscreen menu to instruct the set-top-box to request the program.

In a first embodiment, the request is sent to a central request server that comprises a plurality of gateway servers on the network. The gateway servers are available to accept program requests from the plurality of portals. These gateway servers comprise logical switches that operate as a central routing site and serve as the entry point into the system. The portal requests, which vary in number and in timing, attempt to connect to several gateway servers at onetime, however, the gateway servers assist the portals with selecting the best one by varying their response to incoming requests. Particularly, each gateway server is configured to sleep before responding to a request as its performance level degrades. Correspondingly, each gateway server is configured to decrease its response delay as its performance level improves. Each gateway server is further configured to reject connections if its performance level reaches critical levels. The requesting portal, based on its connection time, contacts the gateway server that is closest to it but the best performing gateway server is selected by adding the performance delay to that connection time. Therefore, the portal connects to the closest, best performing gateway server, which is the first gateway server to respond to the request. The system accordingly provides efficient, global load balancing and prevents any one server from becoming overloaded with requests.

Once the customer's set-top-box connects to a gateway server that will process the request, the central request server replicates the audiovisual stream onto that particular gateway server. Then, the gateway server is able to stream the content to the customer's set-top-box, which preferably includes software that enables reception, decryption, and viewing of the content through a viewer such as a television or monitor. The streamed content automatically adjusts its throughput based on the dynamic conditions of the Internet, thereby maximizing the quality to the customer.

The present embodiment is not limited to the above-described process for replicating streamed content to the gateway server after it is selected to process the request. In an alternative embodiment, when a popular television program is aired and the service provider anticipates a very high demand for that program during a specific time period, the service provider may instruct the central request server that has recorded the program to go ahead and replicate the streamed content to a plurality of gateway servers on the network, even if that central request server hasn't yet received any requests for that program. Therefore, when customers request the popular program through their set-top-boxes, the central request server selects the closest, best performing gateway server that already has the requested content. When the peak time of requests for the popular program is over, the service provider can instruct the central request server to delete the content from certain gateway servers so that the network is not overloaded with low demand content.

Also, the present embodiment of the invention is not limited to waiting until an aired television program is over before it can process portal requests. Rather, as soon as the program begins and the central request server begins recording the program, the central request server can begin replicating the streamed content to the gateway servers.

In a second embodiment, the customer's request from the set-top-box is sent to the central request server on the network. The set-top-box (requesting portal) is considered a peer node on its virtual local access network (VLAN), such as the VLAN provided by the portal's Internet service provider. Once the requesting portal and central request server have been authenticated, the central request server replicates the stream onto the set-top-box.

Assuming that the set-top-box mentioned above is the first peer on the VLAN to request the stream, when other peer portals on the network subsequently request the stream, the set-top-box becomes a transmitter node and the other requesting portals are considered peer nodes. The new peer nodes then form a data transport connection with the transmitter node (set-top-box). The transmitter node replicates the stream to those new peers. As new peers on the network request the stream, peers already having the stream may become transmitting nodes so the process is repeated. Ultimately, each peer on the VLAN is connected to one another and to the central request server so that the quickest and best source for the stream is utilized.

When a peer on a new or different VLAN requests the media stream, that peer may connect to the central request server and to a transmitter on the first VLAN. The peer on the new VLAN then receives the stream and may become a transmitter for replicating the stream to other peers on the new VLAN upon peer request. Again, each peer receives the stream from the best and most efficient source. Therefore, the distribution system provides constant load balancing. The peer-sharing network also allows for automatic redundancy.

The set-top-box described in both of the above-described embodiments preferably includes a software preference engine that stores viewer selections in the set-top-box and creates a viewer profile representing viewing preferences. An image output device may also be provided in the set-top-box that organizes and displays viewer preferences representing available content, along with an alternative search engine that allows the viewer to see alternative selections.

Certain modifications and improvements will occur to those skilled in the art upon a reading of the forgoing description. By way of example, the present invention is not limited to a set-top-box requesting a program. Rather, any type of portal that facilitates communication via the Internet may utilize the communication system of the present invention. Further, the present invention is not limited to storing and supplying television programs upon demand. The service provider may provide access to a library of stored movies that may be streamed to the user's set-top-box in the same ways as television programs. All such modifications and improvements of the present invention have been deleted herein for the sake of conciseness and readability but are properly within the scope of the present invention.

1. A system for providing audiovisual media to a plurality of portals on a network comprising:
a central request server on the network that stores the media;
at least one requesting portal that requests the media from the central request server; and
a gateway server that is selected by the central request server to process the request from the requesting portal;
wherein the central request server replicates the media onto the selected gateway server; and
wherein the selected gateway server replicates the media onto the requesting portal.

2. The system of claim 1 wherein the central request server selects the closest, best performing gateway server on the network from a plurality of gateway servers.

3. The system of claim 1 wherein the central request server simultaneously replicates the media onto a plurality of gateway servers on the network.

4. A system for providing audiovisual media to a plurality of portals on a network comprising:
a central request server on the network that stores the media; and
at last one requesting portal that requests the media from the central request server;
wherein the central request server replicates the media onto the requesting portal; and
wherein when additional portals request the media, the requesting portal becomes a transmitter node on the network and replicates the media onto the additional requesting portals.
